(19) United States
(12) Patent Application Publication
(10) Pub. No.: US 2002/0085659 A1
(43) Pub. Date: Jul. 4, 2002

(54) Flexible data rate matching apparatus and method in a data communication system

(75) Inventors: Min-Goo Kim, Kyonggi-do (KR); Young-Hwan Lee, Kyonggi-do (KR); Jin-Soo Park, Seoul (KR); Ho-Kyu Choi, Seoul (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 09/840,389

(22) Filed: Apr. 23, 2001

(30) Foreign Application Priority Data
Apr. 21, 2000 (KR) 22039/2000
Apr. 24, 2000 (KR) 21672/2000
Apr. 26, 2000 (KR) 22295/2000
Apr. 27, 2000 (KR) 22521/2000

(51) Int. Cl. H04B 3/36

(52) U.S. Cl. 375/377

(57) ABSTRACT

There is provided a method for generating a stream of N symbols by puncturing a stream of repeated symbols in a system including an encoder for generating a stream of L symbols, a repeater for repeating the stream of L symbols, and a puncturer for puncturing the stream of repeated symbols and generating a stream of N symbols, where N is larger than L. The method comprises generating a stream of LM repeated symbols by repeating the stream of L symbols M times, where M is an minimum integer larger than N/L; calculating a first puncturing interval D1 defined as a minimum integer larger than LM/P for a number, P=LM−N, of symbols to be punctured, and a first symbol puncturing number P1 defined as a maximum integer smaller than LM/D1; calculating a second symbol puncturing number P2 indicating a difference between the number P of the symbols to be punctured and the first symbol puncturing number P1, and a second puncturing interval D2 defined as sD1 for a selected one integer s out of integers smaller than or equal to a maximum integer smaller than P1/P2; and generating a stream of N symbols by puncturing the stream of LM repeated symbols at the first puncturing interval D1 and the second puncturing interval D2.

### PRIORITY

This application claims priority to an application entitled “Flexible Data Transmission Apparatus and Method in a Data Communication System” filed in the Korean Industrial Property Office on Apr. 21, 2000 and assigned Serial No. 2000-22039; an application entitled “Flexible Data Transmission Apparatus and Method in a Data Communication System” filed in the Korean Industrial Property Office on Apr. 24, 2000 and assigned Serial No. 2000-21672; an application entitled “Flexible Data Transmission Apparatus and Method in a Data Communication System” filed in the Korean Industrial Property Office on Apr. 26, 2000 and assigned Serial No. 2000-22295; and an application entitled “Flexible Data Transmission Apparatus and Method in a Data Communication System” filed in the Korean Industrial Property Office on Apr. 27, 2000 and assigned Serial No. 2000-22521, the contents of all of which are hereby incorporated by reference.

### BACKGROUND OF THE INVENTION

1. Field of the Invention

The present invention relates generally to a data communication system, and in particular, to an apparatus and method for matching a frame having coded symbols flexibly determined according to variation of a data rate to an interleaver size.

2. Description of the Related Art

In a radio communication system such as a satellite system, an ISDN (Integrated Services Digital Network) system, a digital cellular system, a W-CDMA (Wideband Code Division Multiple Access) system, a UMTS (Universal Mobile Telecommunications System) system, and IMT-2000 (International Mobile Telecommunication-2000) system, a channel coding scheme chiefly uses a convolutional code, and a linear block code for which a single decoder is used. Symbols coded by such a channel coding scheme are generally interleaved by a channel interleaver.

A typical channel interleaver was designed to perform interleaving by receiving a frame having coded symbols, the number of which is identical to an interleaver size per frame. However, a recent FDRT (Flexible Data Rate Transmission) channel interleaver performs interleaving by receiving a frame having coded symbols, the number of which is different from an interleaver size per frame.

FIG. 1 illustrates a non-FDRT (or fixed data rate transmission) channel interleaver which performs interleaving by receiving a frame having coded symbols, the number of which is identical to an interleaver size.

Referring to FIG. 1, in the non-FDRT mode where the data rate of a channel is fixed, the number L of coded symbols per frame, input to a channel interleaver 100, is always equal to an interleaver size N. For example, RC (Radio Configuration) used in the IMT-2000 communication system includes various transmission channel types such as RC1, RC2, RC3, RC4, RC5, RC6, RC7, RC8 and RC9, having different data frame size, code rate and interleaving mode. Accordingly, in the non-FDRT mode, only a predetermined fixed data rate is used.

FIG. 2 illustrates an example of a coded symbol frame format transmitted in the non-FDRT mode.

Referring to FIG. 2, if it is assumed that a physical channel is set to an RC3 data rate=19.2 Kbps, then the size of the channel interleaver 100 shown in FIG. 1 becomes N=1536. Data transmitted as 19.2 Kbps in 20 msec periods have 384 bit per sec, and data after channel encoder which has ¼ as R are to have 1536 bit per sec. At this moment, if the user desires to transmit the frame at a data rate 20 Kbps, a base station and a mobile station determine a data rate 38.4 Kbps out of available data rates higher than the desired data rate 20 Kbps, in an initial negotiation process. This is because the data rate 38.4 Kbps is the least data rate higher than 20 Kbps. When the data rate is set to 38.4 Kbps, the size of the channel interleaver 100 is doubled to N=3072 (=2×1536).

When the data rate increases from 20 Kbps to 38.4 Kbps as stated above, null data is written by an upper layer in an empty interval corresponding to an interval excepting the 20 Kbps×20 msec period out of the data symbols input to a channel encoder (not shown). That is, the channel interleaver with size N writes (38.4−20)/38.4=47.92% of its output with null data before transmission. Therefore, from the viewpoint of reception symbol energy Es, it can be presumed that 47.92% of energy is lost. The reason that an energy loss occurs is because the physical layer has no way to process the null data in the non-FDRT scheme. Even though the null data is subjected to symbol repetition before transmission, a forward supplemental channel (F-SCH) scheme has a disadvantage that it cannot perform symbol combining. Further, since the null data is different according to a data rate of the input data, the upper layer must previously send the null data to the base station and the mobile station. In addition, energy of the null data must be restored before the null data passes through a channel decoder, and the upper layers L1/L2 process only the decoded information symbols after the channel decoder, thus causing a decrease in decoding performance.

The FDRT scheme has been proposed to solve the problem and improve the performance of the non-FDRT scheme. Active research has been made on the FDRT rate matching technique for increasing the data transmission efficiency of the channel coding scheme and improving the system performance in a multiple access and multi-channel system using the channel coding scheme. The principles of the FDRT technique are based on the assumption that the used channel code is a convolutional code, a linear block code, or a convolutional code using a concatenated code. In particular, for the 3GPP (3^{rd} Generation Project Partnership) IS-2000 air interface, the FDRT rate matching technique has been provisionally determined as the standard specification to increase the data rate efficiency of the channel coding scheme and improve the system performance in the multiple access and multi-channel system, and research is presently being conducted on the implementation of this technique.

FIG. 3 illustrates a structure of a flexible data rate transmission (FDRT) rate matching device according to the prior art.

Prior to describing FIG. 3, various terminologies used herein are defined in Table 1 below. That is, c[n], d[n], f[n] and r[n] in FIG. 3 each indicate the data symbols defined in Table 1. Here, the “symbol” is expressed with one bit having a value of ‘1’ or ‘0’. In general, the symbol is comprised of one or more bits. Herein, however, every data bit expressed with one bit will be referred to as a “symbol”.

TABLE 1

| Terms | Definitions |
|---|---|
| c[n] | Coded symbols (0 . . . L-1) from Channel encoder |
| r[n] | Repeated coded symbols (0 . . . LM-1) by repetition |
| f[n] | Punctured coded symbols (0 . . . N-1) by FDRT |
| d[n] | Interleaved coded symbols (0 . . . N-1) by Channel interleaver |

In Table 1, c[n] indicates coded symbols output from the a channel encoder (not shown), and r[n] indicates coded symbols repeated by a repeater 110. Further, f[n] indicates coded symbols punctured by a puncturer 120 out of the repeated coded symbols, and f[n] indicates coded symbols interleaved by the interleaver 100 out of the punctured coded symbols. The channel encoder outputs a stream (or sequence) of L coded symbols. The repeater 110 repeats the L coded symbols M times and outputs LM symbols. The puncturer 120 punctures P symbols out of the LM repeated coded symbols, and thus outputs N FDRT-processed symbols. The channel interleaver 100 interleaves a stream of the N FDRT-processed symbols.

For reference, since L≦N in the FDRT scheme, the input coded symbols are always subjected to repetition. This is because the FDRT scheme is so designed as to guarantee a data rate of input transmission data to be matched with an IS-2000 channel interleaver size. Hence, the FDRT scheme includes the puncturer used for matching the interleaver size N=LM−P after repetition, so that the number of transmitted symbols is fundamentally higher than the number L of the coded symbols.

Referring to FIG. 3, when the number L of the coded symbols is smaller than the channel interleaver size N, the repeater 110 repeats the coded symbols M times. In case of an IS-2000 system, since the channel interleaver size increases/decreases a multiple of 2 according to a spreading factor (SF), M becomes 2 at least. Since the number of the coded symbols repeated by the repeater 110 is larger than N, the puncturer 120 performs puncturing in order to match the number of the repeated coded symbols to the size N of the channel interleaver 100.

FIGS. 4A to 4D illustrate a format of a coded symbol frame reassembled by the repeater 110 and the puncturer 120 in the flexible data rate transmission (FDRT) matching device shown in FIG. 3.

Specifically, FIG. 4A illustrates L coded symbols within one frame, and FIG. 4B illustrates LM coded symbols repeated M times by the repeater 110. Further, FIG. 4C illustrates the LM coded symbols, where N coded symbols are to be interleaved by the channel interleaver 100 and LM−N coded symbols are to be punctured by the puncturer 120. Here, the LM−N coded symbols are distributed such that the symbols should be uniformly punctured within the frame at intervals of D. Finally, FIG. 4D illustrates the coded symbols after puncturing, and the resulting coded symbols are provided to the channel interleaver 100 for channel interleaving.

Referring to FIGS. 4A to 4D, the reassembled coded symbol frame will be compared with the non-FDRT coded symbol frame shown in FIG. 2. In the FDRT scheme, there is no null data within the frame and every symbol is processed as a coded symbol. By using the FDRT scheme rather than the non-FDRT scheme, the receiver can increase energy of the coded symbol received at the same transmission power. The coded symbol energy refers to the energy of the coded symbols after symbol combining. In this way, it is possible to decrease the transmission power of the base station, required in guaranteeing the same QoS (Quality of Service), thereby causing an increase in the channel capacity.

In FIG. 4C, black blocks indicate the symbols to be punctured and ‘D’ indicates a puncturing distance. The puncturing distance D is a parameter for determining a puncturing method performed to output N symbols from LM symbols. An FDRT algorithm is used to specify the relationships among the parameters L, M, N, P and D.

Table 2 below discloses the FDRT algorithm defined in the IS-2000 specification. In the following description, the FDRT algorithm will be described using the original terminologies excerpted from the original document, for convenience of explanation.

TABLE 2
If variable-rate Reverse Supplemental Channel operation, flexible data
rates, or both are supported, puncturing after symbol repetition is
calculated as described here. However, the puncturing in
3.1.3.1.6.1 and 3.1.3.1.6.2 is
used for the frame formats listed in Table 3.1.3.10.2-1 for the Forward
Dedicated Control Channel, Table 3.1.3.11.2-1 for the Forward
Fundamental Channel,
or Tables 3.1.3.12.2-1, 3.1.3.12.2-2, or 3.1.3.12.2-3
for the Forward Supplemental Channel.
The number of repeated symbols punctured per frame is defined by
P = LM − N
where L = Number of specified encoded symbols per frame at encoder
output
N = Desired channel interleaver size (N ≧ L)
M = ┌N/L┐ is the symbol repetition factor for flexible data rate
If P is equal to 0, then puncturing is not required. If puncturing is
necessary, every D^{th} repeated symbol is deleted until
the required number of punctured symbols per frame, P,
is achieved. That is, if the unpunctured
symbols are numbered from 1 to LM, then symbols numbered D,
2D, 3D, . . . are deleted.
D = └LM/P┘ for P > 0; otherwise, puncturing is not required.

As shown in the FDRT algorithm of Table 2, the parameter D is determined from given parameters L and N, and then, every D^{th} coded symbol is punctured from the first coded symbol using the determined parameter value D, thereby finally puncturing P=LM−N coded symbols. However, since the FDRT does not consider the following conditions in view of the characteristics of the convolutional code, it may have a performance degradation problem.

The convolutional code and the linear block code using a single decoder are generally used for the channel coding scheme. In this case, the following conditions should be fully considered and reflected during puncturing in the FDRT scheme for increasing a data transmission efficiency of the channel encoding scheme and improving the system performance in the multiple access and multi-channel system using the channel encoding scheme.

Condition (1): An input symbol sequence is punctured with a puncturing pattern having a specific period;

Condition (2): The number of the punctured bits of the input symbols is minimized, if possible; and

Condition (3): The coded symbols output from an encoder are punctured using a uniform puncturing pattern.

The foregoing conditions are based on the assumption that error sensitivity of the coded symbols output from the channel encoder is almost similar with respect to every symbol in one frame (or codeword). When data is actually transmitted in the FDRT mode, it is possible to obtain an affirmative outcome by using the above conditions as major puncturing restriction factors. However, in most cases, the IS-2000 FDRT scheme does not satisfy the above conditions.

FIG. 5 illustrates how the FDRT device shown in FIG. 3 punctures the coded symbols before transmission. Specifically, FIG. 5 illustrates a puncturing pattern used when transmitting 15 Kbps symbols at RC3 data rate=19.2 Kbps in the FDRT mode. That is, FIG. 5 is a diagram for explaining a problem that may occur when the foregoing conditions are not satisfied. A condition used in FIG. 5 is shown in Table 3 below.

TABLE 3

IS-2000 RC3 (Code rate R = 1/4)
Maximum Assigned Data Rate 19.2 kbps N = 1536 bits
Input Data Rate 15 kbps
Coded symbols per frame (L) = 1200 bits
M = ┌N/L┐ = ┌1536/1200┐ = 2
P = 864 bits (LM − N = 2400 − 1536)
D =└LM/P┘ = └2400/864┘ = └2.778┘ = 2

Referring to FIG. 5, it is noted that puncturing is actually performed only at the leading 1728 bits of the coded symbol frame and not performed in the following 672-bit interval of the frame. For reference, in FIG. 5, the black blocks indicate the punctured symbols and the dotted blocks indicate 672 symbols which are repeated twice before transmission. The leading 1728 twice-repeated symbols are selectively transmitted every other symbol. In this method, N=1536 (=864+672) symbols are formed (or assembled). The N=1536-bit format in the frame violates the Condition (3) above. Therefore, the FDRT scheme may have a performance degradation problem due to non-uniform puncturing.

FIG. 6 is a diagram for explaining the problem of the conventional FDRT scheme. Specifically, FIG. 6 illustrates distribution of the symbol energy and the number of symbols per unit frame at the final stage of the receiver.

Referring to FIG. 6, a channel receiver 200 receives the symbols transmitted in the FDRT mode and provides the received symbols to an erasure insertion and symbol combining part 210. FIG. 6 shows the relative distribution of the symbol energy Es for the respective symbols when the symbol combining part 210 performs symbol combining on the provided symbols. As illustrated, when the symbol energy Es of 864 unrepeated symbols is generalized to 1.0, the following 672 repeated symbols are subjected to symbol combining with M=2, making Es become 2.0. Therefore, the tail symbols have an average gain of Es/No=+3 dB in the same channel environment. That is, an R=¼ channel decoder 220 decodes the non-uniformly distributed 1200 symbols and outputs 300 information symbols. As will be described later with reference to FIGS. 12 and 13, it is noted from the simulation results that the conventional FDRT device has considerable performance degradation.

The occurrence of the non-uniform puncturing is caused by the value D which determines the puncturing pattern. That is, when LM/P is not an integer, the conventional IS-2000 FDRT algorithm defines the value D as └LM/P┘ indicating a maximum integer smaller than LM/P. In this case, only P×D symbols are actually punctured, and the puncturing is not performed in the remaining P×(LM/P−D)-bit interval. In FIG. 5, for example, since LM/P=2400/864=2.778, D=2 and LM/P−D=0.778. Therefore, the puncturing is performed in the P×D=864×2=1728-bit interval, while the puncturing is not performed in the P×(LM/P−D)=864×0.778=672-bit interval. In conclusion, the non-uniform puncturing occurs due to a difference of (LM/P−D) in the process of determining the value D.

The conventional FDRT scheme has the following disadvantages:

1) The FDRT scheme using the convolutional code or liner block code requires a uniform puncturing scheme in view of the property that error sensitivity of coded symbols output from the channel encoder is almost similar with respect to every symbol within one frame (or codeword). However, since such an assumption is not conducted in the existing IS-2000 FDRT scheme, it is necessary to modify the existing FDRT scheme.

2) From the viewpoint of symbol repetition, the existing IS-2000 FDRT scheme fundamentally regards the FDRT scheme as a repetition scheme, considering that the puncturing pattern is not affected greatly. However, this should be interpreted in the same context as the puncturing. That is, a uniform repetition scheme should be used for the FDRT scheme with optimal performance even in case of the repetition, in view of the property that error sensitivity of the coded symbols output from the channel encoder is almost similar with respect to every symbol within one frame (or codeword). However, since such an assumption is not conducted in the existing IS-2000 FDRT scheme, it is necessary to modify the existing FDRT scheme.

### SUMMARY OF THE INVENTION

It is, therefore, an object of the present invention to provide an apparatus and method for guaranteeing optimal performance without performance degradation when matching a frame having coded symbols flexibly determined according to variation of a data rate to an interleaver size in a data communication system.

It is another object of the present invention to provide a flexible data rate transmission (FDRT) apparatus and method which flexibly operates according to a data rate by simply adjusting its structure and initial setting value in a data communication system using a convolutional code or a linear block code.

To achieve the above and other objects, there is provided a method for generating a stream of N symbols by puncturing a stream of repeated symbols in a system including an encoder for generating a stream of L symbols, a repeater for repeating the stream of L symbols, and a puncturer for puncturing the stream of repeated symbols and generating a stream of N symbols, where N is larger than L. The method comprises generating a stream of LM repeated symbols by repeating the stream of L symbols M times, where M is an minimum integer larger than N/L; calculating a first puncturing interval D1 defined as a minimum integer larger than LM/P for a number, P=LM−N, of symbols to be punctured, and a first symbol puncturing number P1 defined as a maximum integer smaller than LM/D1; calculating a second symbol puncturing number P2 indicating a difference between the number P of the symbols to be punctured and the first symbol puncturing number P1, and a second puncturing interval D2 defined as sD1 for a selected one integer s out of integers smaller than or equal to a maximum integer smaller than P1/P2; and generating a stream of N symbols by puncturing the stream of LM repeated symbols at the first puncturing interval D1 and the second puncturing interval D2.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a conventional non-FDRT channel interleaver;

FIG. 2 is a diagram illustrating a coded symbol frame format transmitted according to the non-FDRT mode;

FIG. 3 is a diagram illustrating a structure of a conventional flexible data rate matching device;

FIGS. 4A to 4D are diagrams illustrating a coded symbol frame format reassembled by a repeater and a puncturer in the flexible data rate matching device shown in FIG. 3;

FIG. 5 is a diagram illustrating an example where the coded symbols are punctured by the FDRT matching device shown in FIG. 3;

FIG. 6 is a diagram for explaining a problem of the conventional FDRT scheme, the diagram illustrating distribution of symbol energy and the number of symbols per unit frame at a final stage of a receiver;

FIG. 7 is a diagram illustrating an exemplary method of puncturing the coded symbols according to a puncturing pattern proposed in the present invention;

FIGS. 8A and 8B are diagrams illustrating distribution of symbol energy and the number of symbols per unit frame at a final stage of a receiver associated with a flexible data rate matching device according to an embodiment of the present invention;

FIG. 9 is a flow chart illustrating a procedure for performing flexible data rate matching and transmission operations according to a first embodiment of the present invention;

FIG. 10 is a diagram illustrating a structure of a flexible data rate matching device according to the first embodiment of the present invention;

FIG. 11 is a diagram illustrating another structure of a flexible data rate matching device according to the first embodiment of the present invention;

FIG. 12 is a flow chart illustrating a procedure for performing flexible data rate matching and transmission operations according to a second embodiment of the present invention;

FIG. 13 is a diagram illustrating a structure of a flexible data rate matching device according to the second embodiment of the present invention;

FIG. 14 is a diagram illustrating another structure of a flexible data rate matching device according to the second embodiment of the present invention;

FIGS. 15 and 16 are diagrams illustrating a comparison between the simulation results of the flexible data rate matching and transmission operations proposed in the present invention and the simulation results according to the prior art.

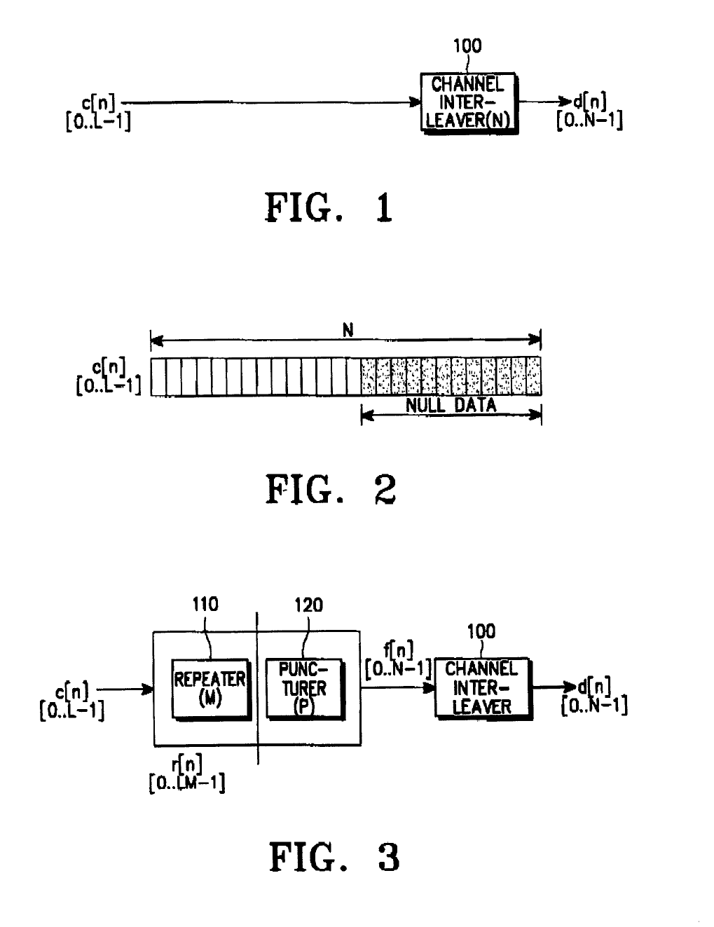

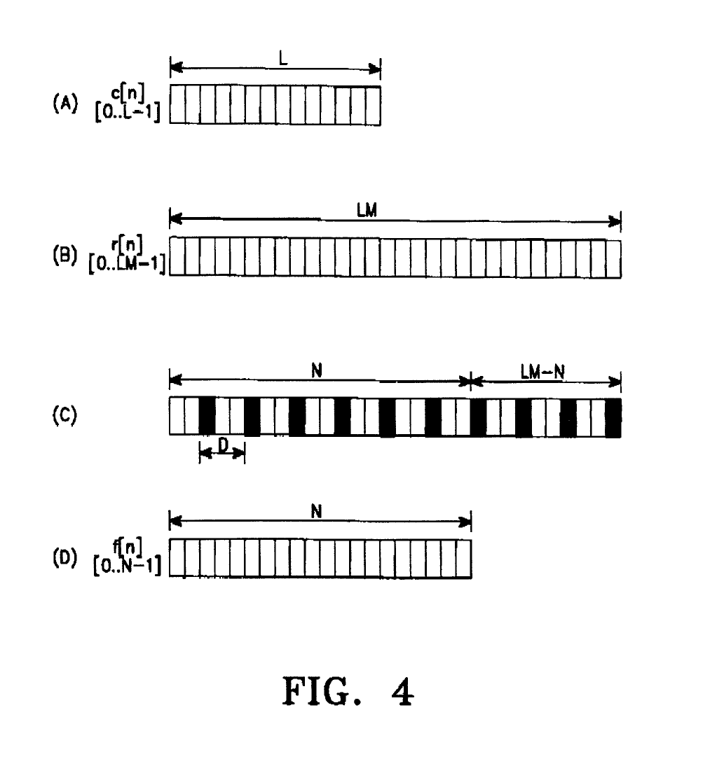

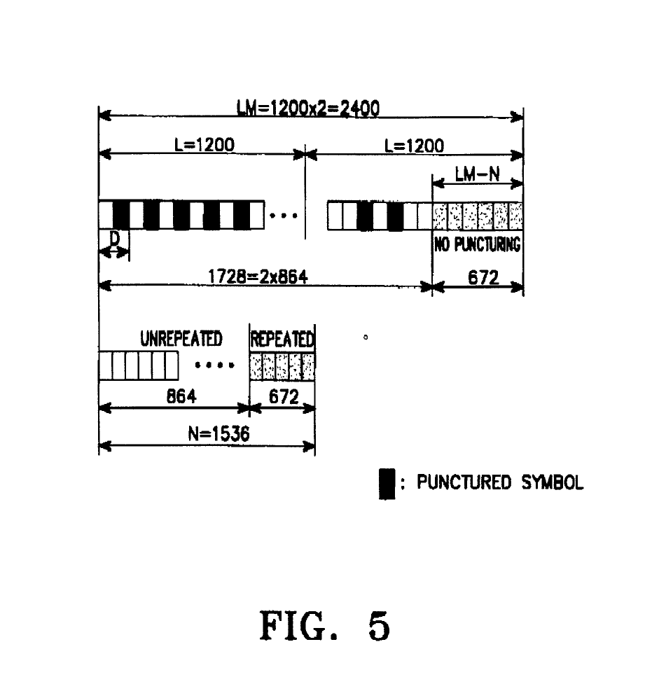

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

The present invention provides an improved FDRT scheme capable of securing uniform puncturing or repetition, thereby solving a problem of the conventional FDRT scheme. To this end, a uniform puncturing pattern or a uniform repetition pattern is required. Therefore, the present invention provides a method for creating a new puncturing pattern for FDRT and then puncturing the coded symbols according to the created new puncturing pattern.

The determination of a proper puncturing distance D is important in performing the uniform puncturing or uniform repetition in the FDRT scheme. In other words, the non-uniform puncturing or repetition is caused by the parameter D for determining the puncturing pattern or the repetition pattern. That is, in the conventional IS-2000 FDRT algorithm, when LM/P is not an integer, └LM/P┘ indicating the maximum integer smaller than LM/P is defined as the parameter D. Therefore, in this case, only P×D bits are actually punctured and the puncturing is not performed in the remaining P×(LM/P−D)-bit period. For example, since LM/P=2.778, D=2 and LM/P−D=0.778. Therefore, the puncturing is performed in the P×D=864×2=1728-bit interval, while the puncturing is not performed in the P×(LM/P−D)=864×0.778=672-bit interval. In conclusion, the non-uniform puncturing occurs due to a difference of (LM/P−D) in the process of determining the value D. To solve this problem, the following basic conditions are introduced, and then an algorithm based on the conditions will be described.

FDRT Condition (1): P×D determined from L and N should satisfy P×D≧LM. That is, D should satisfy D≧LM/P. Here, P and D are integers.

FDRT Condition (2): (P−└LM/D┘) symbols determined from the parameter value D satisfying FDRT Condition (1) are punctured or repeated as uniformly (or at regular intervals) as possible over LM symbols. Here, the determined symbol position should not overlap with the position determined by the parameter D satisfying FDRT Condition (1).

FDRT Condition (3): The non-uniform repetition or puncturing due to a difference of (LM/P−D) in the process of determining the parameter D should be minimized.

Now, an operation of the FDRT scheme according to an embodiment of the present invention will be described, considering the above FDRT conditions. First, a description will be made of an embodiment to which the FDRT algorithm according to the present invention is applied. Subsequently, a generalized FDRT algorithm will be described.

New Flexible Data Rate Transmission Algorithm Type 1

A description will be made of an embodiment to which the FDRT algorithm according to the present invention is applied. The conditions used in this embodiment are shown in Table 4 below, and the algorithm is shown in Table 5 below.

Referring to Table 4, the embodiment of the present invention is applied to IS-2000 RC3. The maximum assigned data rate is 19.2 Kbps, the interleaver size is N=1536 bits, and an input data rate is 15 Kbps. Further, the number of coded symbols per frame is L=1200 bits. Therefore, the number of repetitions for the L=1200 coded symbols becomes M=2. The repetition number M is defined as the minimum integer larger than N/L (=(interleaver size)/(coded symbols per frame)). That is, the repetition number M is defined as M=┌N/L┐. The number P of coded symbols to be punctured is determined by subtracting the interleaver size N from the repeated coded symbols LM. The puncturing distance D is defined as D=┌LM/P┐.

TABLE 4

IS-2000 RC3 (Code rate R = 1/4)
Maximum Assigned Data Rate 19.2 kbps [N = 1536 bits]
N = 1536 bits
Input Data Rate = 15 kbps
Coded symbols per frame (L) = 1200 bits
M = ┌N/L┐ = ┌1536/1200┐ = 2
P = 864 bits (LM-N = 2400 − 1536)
D = ┌LM/P┐ = ┌2400/864┐ = ┌2.778┐ = 3

TABLE 5
D = ┌LM/P┐ = 3
The repeated symbol is deleted if the following condition is satisfied.
If (k mod 3 = 2 or k mod 36 = 0) then Puncturing
where k = 0, 1, 2, . . . , 2399

Referring to Table 5, in the algorithm according to an embodiment of the present invention, “k mod(?) 3” indicates a modulo-3 operation of calculating a remainder determined by dividing k by 3. FDRT Condition (1) is used in the process of calculating D, and FDRT Condition (2) is used in the process having a variable ‘36’.

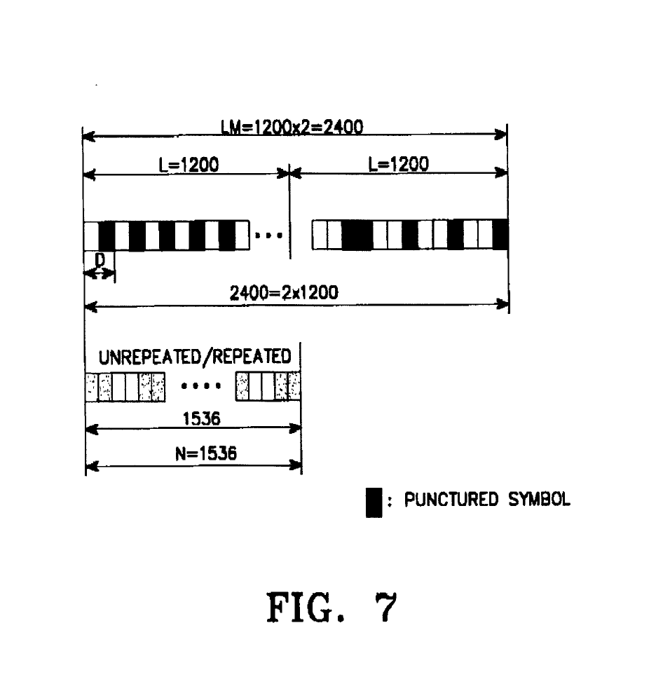

FIG. 7 illustrates an exemplary method of puncturing the coded symbols according to a puncturing pattern proposed in the present invention. This method is based on the condition of Table 4 and the algorithm of Table 5.

Referring to FIG. 7, it is noted that the puncturing is actually uniformly performed over the overall interval of the coded symbol frame. In FIG. 7, the black blocks indicate the punctured symbols. Further, it is noted that the symbols transmitted after twice repetition and a selected one of the symbols transmitted after twice repetition are uniformly distributed. Therefore, the N=1536 frame has a symbol format coincident with FDRT Condition (3). Hence, such an FDRT scheme is free from performance degradation because of the uniform puncturing, and has a near-optimal performance.

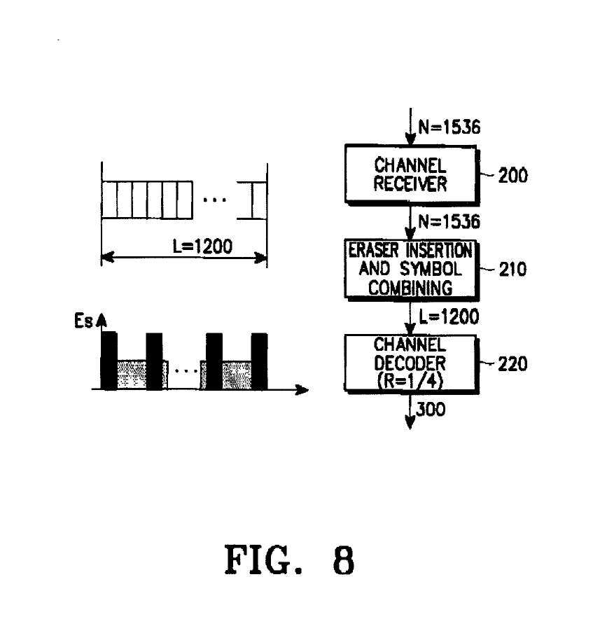

FIGS. 8A and 8B illustrate distribution of symbol energy and the number of symbols per unit frame at the final stage of a receiver associated with a flexible data rate matching device according to an embodiment of the present invention.

Referring to FIGS. 8A and 8B, a channel receiver 200 receives the symbols transmitted in the inventive FDRT mode and provides the received symbols to an erasure insertion and symbol combining part 210. The symbol combining part 210 outputs 1200 symbols, as shown in FIG. 8A, and the output symbols have the relative symbol energy distribution shown in FIG. 8B. As illustrated, when the symbol energy Es of 864 unrepeated symbols is generalized to 1.0, the following 672 repeated symbols are subjected to symbol combining with M=2, making Es become 2.0. FIG. 8B shows that the symbols are uniformly distributed over the entire interval. The uniform symbol distribution contributes to performance improvement of a channel decoder 220, for which a Viterbi decoder is typically used.

Generalized Flexible Data Rate Transmission Algorithm GFDRTA-I

A generalized flexible data rate transmission algorithm according to the present invention will be described. The FDRT algorithm and the parameters used in the algorithm are defined in Table 6.

TABLE 6
P = LM − N
where L = Number of specified encoded symbols per frame at encoder
output
N Desired channel interleaver size (N ≧ L)
M = ┌N/L┐ is the symbol repetition factor for flexible data rate

In table 6, L indicates the number of coded symbols per frame, out of streams of the coded symbols output from the encoder. Further, N indicates a predetermined channel interleaver size, and is defined as a value larger than or equal to the number L of the coded symbols per frame. In addition, M indicates the number of repetitions for the coded symbols, and is defined as ┌N/L┐. That is, the repetition number M is defined as the minimum integer larger than N/L. Therefore, the number P of the coded symbols to be punctured is defined as P=LM−N.

As a first embodiment, in the algorithm of Table 6, if P=0, then the puncturing is not performed. In the puncturing process, every D1^{th} symbol and every (D2+1)^{th} symbol (where D2 is an even number) out of the LM coded symbols are punctured, until P symbols are punctured per unit frame. That is, when the LM coded symbols are ordered from 1 to LM, the D1^{th}, 2D1^{th,} 3D1^{th}, . . . coded symbols and the (D2+1)^{th}, (2D2+1)^{th}, (3D2+1)^{th}, . . . coded symbols (where D2 is an even number) are punctured. Here, the (D2+1)^{th}, (2D2+1)^{th}, (3D2+1)^{th}, . . . coded symbols are punctured so as not to overlap with the mD1^{th} (where m=1,2,3 . . .) coded symbols in terms of puncturing positions. Therefore, if necessary, it is possible to consider another method for preventing the (D2+1)^{th}, (2D2+1)^{th}, (3D2+1)^{th}, . . . coded symbols from overlapping with the mD1^{th} (where m=1,2,3, . . .) coded symbols. For example, it is also possible to puncture (D2−1)^{th}, (2D2−1)^{th}, (3D2−1)^{th}, . . . coded symbols (where D2 is an odd number) instead of the (D2+1)^{th}, (2D2+1)^{th}, (3D2+1)^{th}, . . . coded symbols. Even in this case, the (D2−1)^{th}, (2D2−1)^{th}, (3D2−1)^{th}, . . . coded symbols are punctured so as not to overlap with the mD1^{th} (where m=1,2,3, . . .) coded symbols in terms of puncturing positions. That is, D1 and D2 indicate puncturing distance values for determining the distances among the P symbols to be punctured out of the LM repeated coded symbols. D1 and D2 used herein are defined by Equation (1) below.

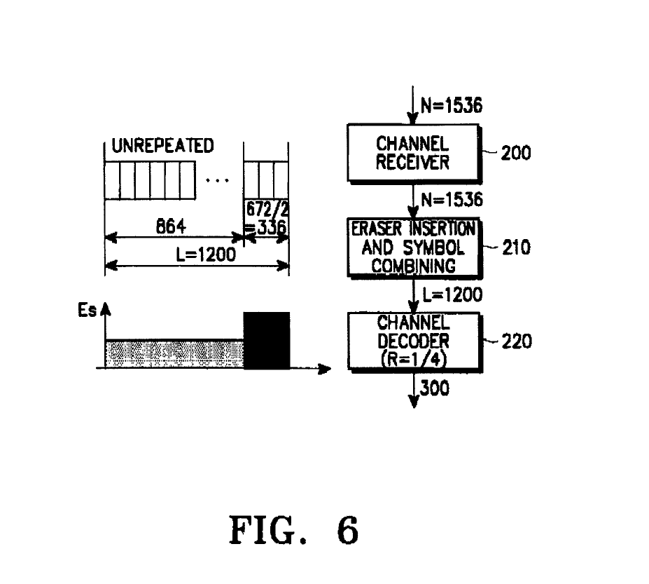

As a second embodiment, in the algorithm of FIG. 6, if P=0, then the puncturing is not performed. In the puncturing process, every D1^{th} symbol and every ((a multiple of D2)−D2+└D1/2┘)^{th} symbol out of the LM coded symbols are punctured, until P symbols are punctured per unit frame. That is, when the LM coded symbols are ordered from 1 to LM, the D1^{th}, 2D1^{th}, 3D1^{th}, . . . coded symbols and the (D2+└D1/2┘)^{th}, (2D2+└D1/2┘)^{th}, (3D2+└D1/2┘)^{th}, . . . coded symbols are punctured. Here, the (D2+└D1/2┘)^{th}, (2D2+└D1/2┘)^{th}, (3D2+└D1/2┘)^{th}, . . . coded symbols are punctured so as not to overlap with the mD1^{th} (where m=1,2,3, . . .) coded symbols in terms of puncturing positions. D1 and D2 used herein are also defined by Equation (1) below.

D1=┌LM/P┐ for P>0: Otherwise, puncturing is not required.

P1=└LM/D1┘

P2=P−P1

D2=sD1 for P2>0: Otherwise, puncturing is nor required. Equation (1)

In Equation (1), s indicates the maximum integer out of integers within a range satisfying Equation (2) below.

(sD1)≦└LM/P2┘,

s≦(└LM/P2┘)/D1=(└LM/D1┘)/P2)=└P1/P2┘ Equation (2)

Referring to Equations (1) and (2), the puncturing distance (or interval) D1 is defined as the minimum integer larger than LM/P for the number, P=LM−N, of the remaining symbols to be punctured. P1 indicates the symbol puncturing number and is defined as the maximum integer smaller than LM/D1. P2 indicates a symbol puncturing number determined by a difference between the total number P of the symbols to be punctured and the symbol puncturing number P1. The puncturing distance D2 is defined as sD1 for an integer ‘s’ out of integers smaller than or equal to the maximum integer smaller than P1/P2.

In Table 6 and Equations (1) and (2), in order to match a stream of L (<N) coded symbols to the interleaver size N, the stream of the L coded symbols is repeated M times thus generating a stream of LM coded symbols, and the stream of the LM repeated coded symbols is punctured at the first puncturing interval D1 and the second puncturing interval D2 according to a first puncturing pattern A and a second puncturing pattern B. Here, the first puncturing pattern A is defined as a multiple of the first puncturing distance D1, while the second puncturing pattern B is defined as a multiple of the second puncturing distance D2 plus an offset. In the first embodiment, the offset is +1 or −1 (offset=±1). In the second embodiment, the offset is either a value determined by subtracting D2 from the maximum integer smaller than D1/2(i.e., offset=−D2+└D1/2┘) or a negative value for a value determined by adding D2 to the maximum integer smaller than D‘/2 (i.e., offset=−D2−└D1/2┘). That is, for the stream of the LM repeated coded symbols, P1 symbols located at the first puncturing interval D1 from the initial symbol are first punctured, and then, P2 symbols located at the second puncturing interval D2 plus an offset (D2+offset) from the initial symbol are punctured. The first puncturing interval D1 and the second puncturing interval D2 are the values for determining the patterns used for puncturing the symbols uniformly distributed in one frame. Therefore, in the first puncturing process, relatively dense puncturing is performed on the stream of the repeated coded symbols constituting one frame, and in the second puncturing process, relatively loose puncturing is performed on the stream of repeated coded symbols.

In other words, for the stream of the LM repeated coded symbols, P1 symbols are punctured, and when the remaining number of the coded symbols after puncturing is larger than the interleaver size N, P2 symbols are punctured for the stream of the (LM−P1) repeated coded symbols. As described above, it is assumed that the embodiment of the present invention performs puncturing on the stream of the repeated coded symbols in two separate steps. This is because even though the number of the coded symbols is smaller than the interleaver size, it is possible to match the number of the coded symbols to the interleaver size by performing puncturing on the repeated coded symbols in two separate steps. Therefore, depending on the circumstances, it is also possible to generate the coded symbols, the number of which is matched to the interleaver size N, in only a single step.

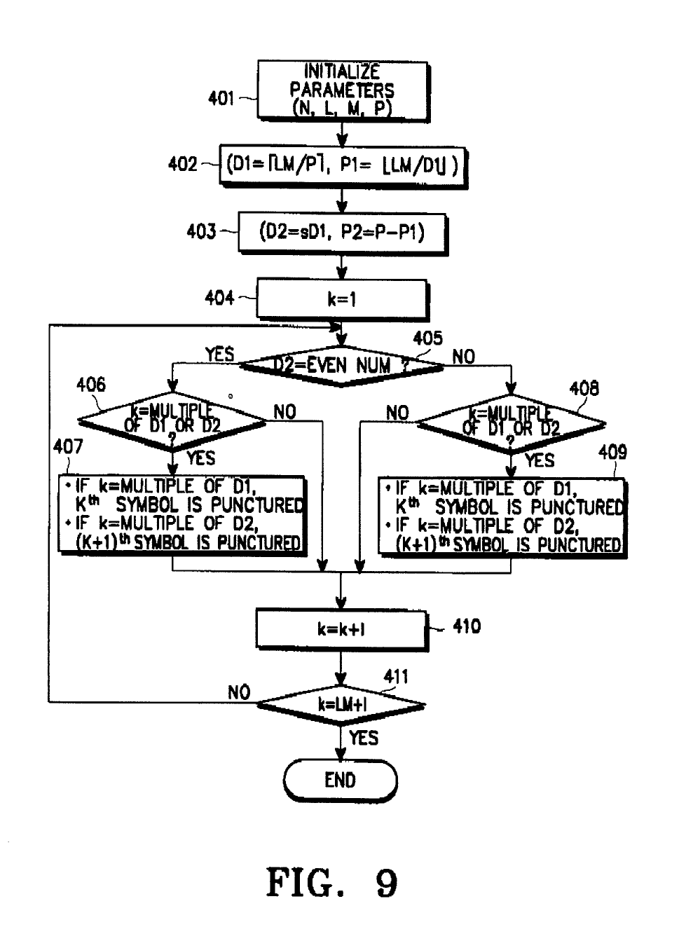

FIG. 9 illustrates a procedure for performing flexible data rate matching and transmission operations, shown in Table 6, according to a first embodiment of the present invention.

Referring to FIG. 9, in step 401, the initial parameters N, L, M and P necessary for FDRT are initialized. The number L of the coded symbols constituting the frame and the interleaver size N are determined according to a given data rate, while the repetition number M and the number P of the symbols to be punctured are determined by the formula in Table 6. In step 402, the first puncturing interval D1 and the first puncturing number P1 are calculated in accordance with the formula given in the algorithm. In step 403, the second puncturing interval D2 and the second puncturing number P2 are calculated in accordance with the formula given in the algorithm. After the parameters are all calculated in steps 402 and 403, steps 404 to 411 are performed while sequentially counting k from 1 to LM. At every counting, if it is determined in steps 405 and 406 that k is a multiple of D1 or D2 (where D2 is an even number), or if it is determined in steps 405 and 408 that k is a multiple of D1 or D2 (where D2 is an odd number), then the corresponding k^{th} coded symbols are punctured in step 407 or 409. In step 405, it is determined whether D2 is an even number or an odd number. If it is determined in step 405 that D2 is an even number, it is determined in step 406 whether k is a multiple of D1 or D2. If it is determined in step 406 that k is a multiple of D1, a k coded symbol is punctured in step 407; otherwise, if it is determined that k is a multiple of D2, a (k+1)^{th} coded symbol is punctured in step 407. However, if it is determined in step 406 that k is neither a multiple of D1 nor a multiple of D2, the procedure goes to step 410 to increase the value k by +1. If it is determined in step 405 that D2 is not an even number but an odd number, it is determined in step 408 whether k is a multiple of D1 or D2. If it is determined in step 408 that k is a multiple of D1, a k^{th} coded symbol is punctured in step 409; otherwise, if it is determined that k is a multiple of D2, a (k−1)^{th} coded symbol is punctured in step 409. However, if it is determined in step 408 that k is neither a multiple of D1 nor a multiple of D2, the procedure goes to step 410 to increase the value k by +1. After step 410, it is determined in step 411 whether k=LM+1. If so, the process ends. If not, the steps 405 to 411 are repeated until it is determined in step 411 that k=LM+1. In this method, a nearly uniform FDRT puncturing pattern is created and puncturing is performed on the stream of the repeated coded symbols according to the created puncturing pattern.

In the operation of steps 401-407, 410 and 411, if it is determined that k is a multiple of D1 or a multiple of D2 plus 1 (where D2 is an even number), then the corresponding k^{th} coded symbol is punctured. In the operation of steps 401-405 and 408-411, if k is a multiple of D1 or a multiple of D2 minus 1 (where D2 is an odd number), then corresponding k^{th} coded symbol is punctured. This is to perform the puncturing at the positions inconsistent with the coded symbols corresponding to a multiple of D1. That is, the coded symbols corresponding to a multiple of D2 plus 1 (where D2 is an even number) or a multiple of D2 minus 1 (where D2 is an odd number) are punctured at the different positions inconsistent with the coded symbols punctured at the positions corresponding to a multiple of D1.

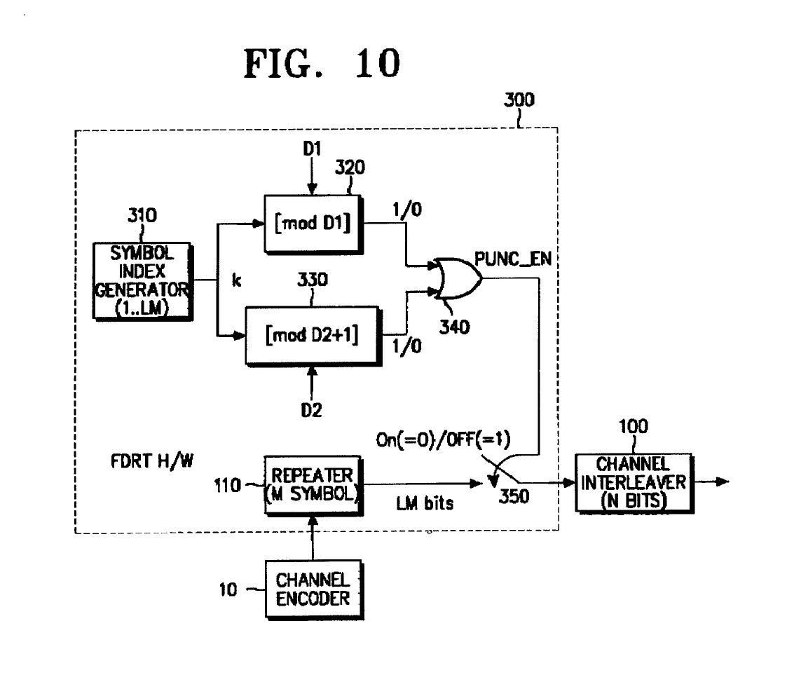

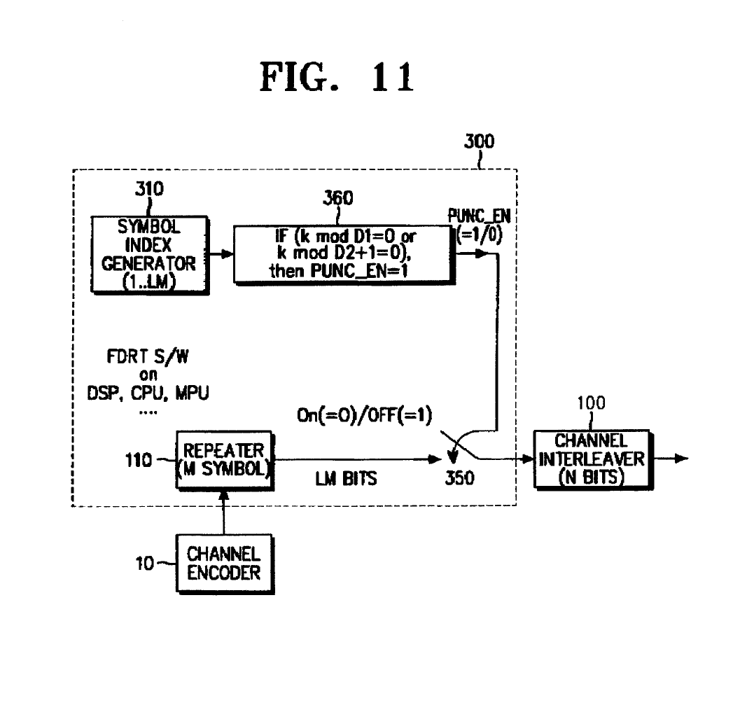

FIGS. 10 and 11 illustrate structures of the flexible data rate matching and transmission devices according to the first embodiment of the present invention. Specifically, FIG. 10 illustrates a hardware structure of the FDRT algorithm, and FIG. 11 illustrates a software structure of the FDRT algorithm. That is, the FDRT device according to the first embodiment of the present invention can be realized with either a software module such as a digital signal processor (DSP), a central processing unit (CPU) and a micro-processing unit (MPU), as shown in FIG. 11, or a hardware module such as an application specific integrated circuit (ASIC), as shown in FIG. 10.

Referring to FIG. 10, the flexible data rate matching device according to an embodiment of the present invention includes a channel encoder 10, a repeater 110, a puncturer 350, a channel interleaver 100, a symbol index generator 310, modulo operators 320 and 330, and an OR gate (or logical sum operator) 340.

The channel encoder 10 generates a stream of L coded symbols. The repeater 110 repeats the stream of L coded symbols M times, and outputs LM repeated code symbols. Here, M indicates the number of times the stream of the L coded symbols is repeated, and is defined as the minimum integer larger than N/L. That is, M=┌N/L┐. The puncturer 350 performs a puncturing operation in response to a puncturing enable signal PUNC_EN from the OR gate 340. That is, the puncturing enable signal PUNC_EN is a puncturing pattern for determining the puncturing operation of the puncturer 350. The N-symbol stream output from the puncturer 350 is interleaved by the channel interleaver 100 having the interleaver size N.

The symbol index generator 310 sequentially generates indexes indicating the symbols constituting the stream of LM repeated symbols. The symbol index generator 310 can be realized with a counter. The modulo operator 320 receives the index k generated from the symbol index generator 310 and D1, and generates the puncturing enable signal PUNC_EN of ‘1’, when the k^{th} coded symbol corresponds to a coded symbol at a puncturing position. For example, in the modulo operator 320, “when the k^{th} coded symbol corresponds to a coded symbol at a puncturing position” refers to when the k^{th} coded symbol corresponds to a multiple of D1. The modulo operator 330 receives the index k generated from the symbol index generator 310 and D2, and generates the puncturing enable signal PUNC_EN of ‘1’, when the k^{th} coded symbol corresponds to a coded symbol at a puncturing position. For example, in the modulo operator 330, “when the k^{th} coded symbol corresponds to a coded symbol at a puncturing position” refers to when the k^{th} coded symbol corresponds to a multiple of (D2+1) (where D2 is an even number) or a multiple of (D2−1) (where D2 is an odd number). The OR gate 340 generates the puncturing enable signal PUNC_EN by ORing the outputs of the modulo operators 320 and 330, and provides the generated puncturing enable signal PUNC_EN to the puncturer 350.

D1 and D2, as described with reference to Table 6, Equations (1) and (2), and FIG. 9, are the puncturing interval values for determining the interval between the symbols to be punctured in the stream of the coded symbols within one frame. The first puncturing interval D1 is defined as the minimum integer larger than LM/P for the number, P=LM−N, of the symbols to be punctured. The second puncturing interval D2 is defined as sD1 for a selected one integer ‘s’ out of integers smaller than or equal to the maximum integer smaller than P1/P2. Here, P1 indicates the first symbol puncturing number and is defined as the maximum integer smaller than LM/D1. P2 indicates the second symbol puncturing number determined by a difference between the total number P of the symbols to be punctured and the first symbol puncturing number P1. That is, D1=┌LM/P┐, P1=└LM/D1┘, P2=P−P1, D2=sD1, and s≦└P1/P2┘. The puncturing intervals D1 and D2 and the symbol puncturing numbers P1 and P2 are provided from a puncturing pattern determiner (not shown). The puncturing pattern determiner, the modulo operators 320 and 330, and the OR gate 340 serve as a puncturing pattern generator for generating a puncturing enable signal for determining a puncturing operation of the puncturer 350.

Referring to FIG. 11, as in the flexible data rate matching device shown in FIG. 10, the flexible data rate matching device according to an embodiment of the present invention includes the channel encoder 10, the repeater 110, the puncturer 350, the channel interleaver 100, and the symbol index generator 310. The flexible data rate matching device shown in FIG. 11 is featured by including a puncturing pattern generator 360 in place of the modulo operators 320 and 330 and the OR gate 340 of FIG. 10. By doing so, the flexible data rate matching device is realized by software. The puncturing pattern generator 360 stores an address generator module program, and generates the puncturing enable signal ‘1’ when k satisfies a specific condition according to the program. The puncturing pattern generator 360 determines the k^{th} coded symbols corresponding to the case where k is a multiple of D1 or a multiple of D2 plus 1 (where D2 is an even number), to puncture the determined coded symbols. The puncturing pattern generator 360 may also determine the k^{th} coded symbols corresponding to the case where k is a multiple of D1, a multiple of D2 plus 1 (where D2 is an even number), or a multiple of D2 minus 1 (where D2 is an odd number), to puncture the determined coded symbols. Then, the flexible data rate matching device actually outputs N symbols out of LM symbols, as in the flexible data rate matching device of FIG. 10.

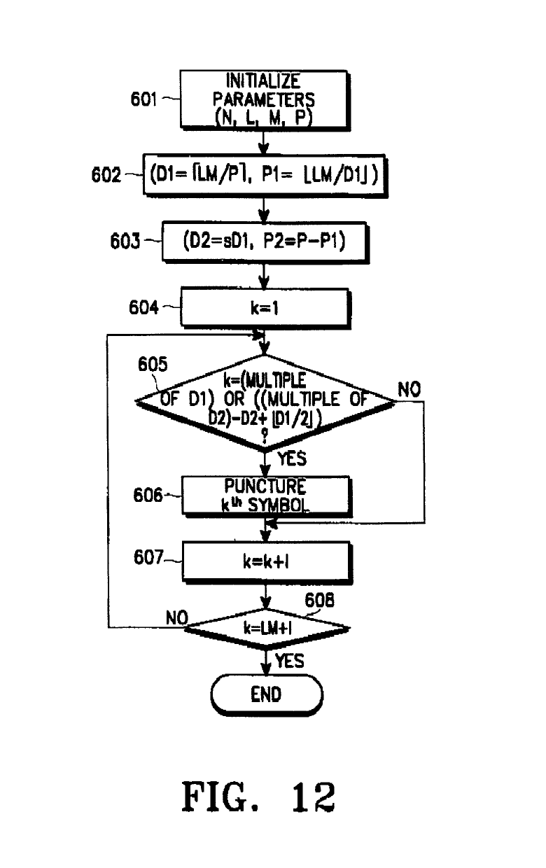

FIG. 12 illustrates a procedure for performing flexible data rate matching and transmission operations, shown in Table 6, according to a second embodiment of the present invention.

Referring to FIG. 12, in step 601, the initial parameters N, L, M and P necessary for FDRT are initialized. The number L of the coded symbols constituting the frame and the interleaver size N are determined according to a given data rate, while the repetition number M and the number P of the symbols to be punctured are determined by the formula in Table 6. In step 602, the first puncturing interval D1 and the first puncturing number P1 are calculated in accordance with the formula given in the algorithm. In step 603, the second puncturing interval D2 and the second puncturing number P2 are calculated in accordance with the formula given in the algorithm. After the parameters are all calculated in steps 602 and 603, steps 604 to 608 are performed while sequentially counting k from 1 to LM. At every counting, if it is determined in step 605 that k is (a multiple of D1) or ((a multiple of D2)−D2+└D1/2┘), then the corresponding k^{th} coded symbols are punctured in step 606. If it is determine in step 605 that k is neither (a multiple of D1) nor ((a multiple of D2)−D2+└D1/2┘), the procedure goes to step 607 to increase the value k by +1. After step 607, it is determined in step 608 whether k=LM+1. If so, the process ends. If not, the steps 605 to 608 are repeated until it is determined in step 608 that k=LM+1. In this method, an almost uniform FDRT puncturing pattern is created.

In FIG. 12, if it is determined that k is (a multiple of D1) or ((a multiple of D2)−D2+└D1/2┘), then the corresponding k^{th} coded symbol is punctured. Alternatively, if k is (a multiple of D1) or ((a multiple of D2)−D2└D1/2┘), then the corresponding k^{th} coded symbol is punctured. This is to perform the puncturing at the positions inconsistent with the coded symbols corresponding to a multiple of D1, and also, to prevent the puncturing range from surpassing the range of LM. In addition, this is to keep the puncturing position of D1 away from the puncturing position of D2 as wide as possible, as the D1 value increases more and more. That is, the coded symbols corresponding to ((a multiple of D2)−D2+└D1/2┘) are punctured at the different positions inconsistent with the coded symbols punctured at the positions corresponding to a multiple of D1.

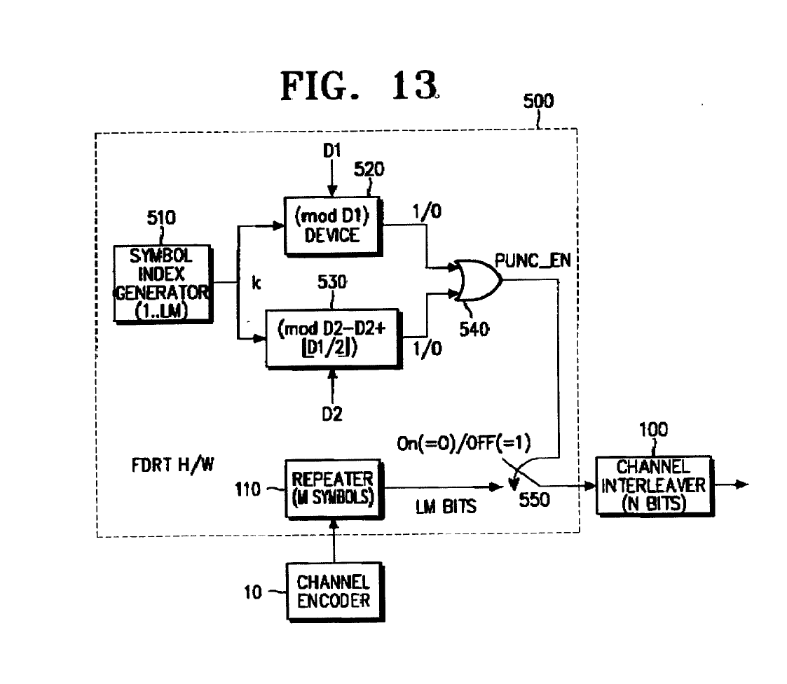

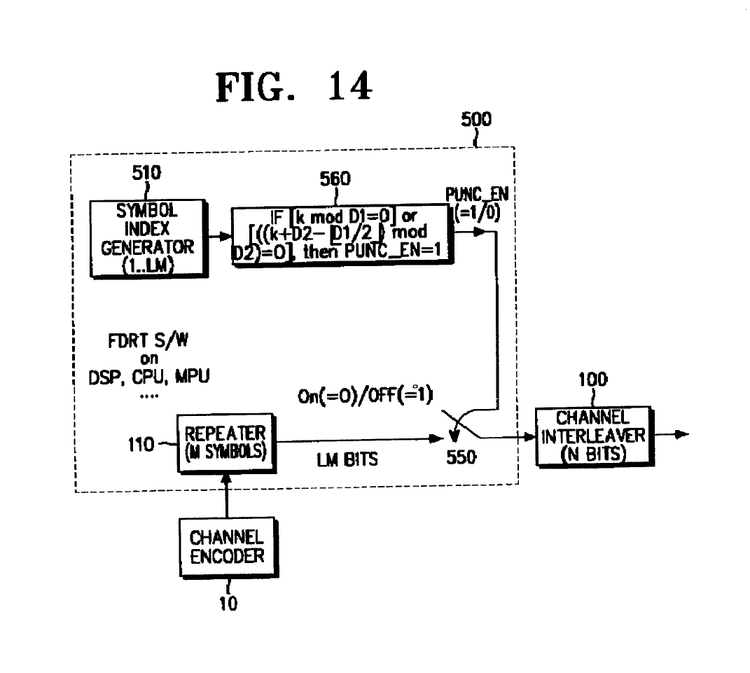

FIGS. 13 and 14 illustrate structures of the flexible data rate matching and transmission devices according to the second embodiment of the present invention. Specifically, FIG. 13 illustrates a hardware structure of the FDRT algorithm, and FIG. 14 illustrates a software structure of the FDRT algorithm. That is, the FDRT device according to the second embodiment of the present invention can be realized with either a software module such as a DSP and a CPU, as shown in FIG. 14, or a hardware module such as an ASIC, as shown in FIG. 13.

Referring to FIG. 13, the flexible data rate matching device according to an embodiment of the present invention includes a channel encoder 10, a repeater 110, a puncturer 550, a channel interleaver 100, a symbol index generator 510, modulo operators 520 and 530, and an OR gate (or logical sum operator) 540.

The channel encoder 10 generates a stream of L coded symbols. The repeater 110 repeats the stream of L coded symbols M times, and outputs LM repeated code symbols. Here, M indicates the number of times the stream of the L coded symbols is repeated, and is defined as the minimum integer larger than N/L. That is, M=┌N/L┐. The puncturer 550 performs puncturing on the stream of the LM repeated symbol and outputs a stream of N symbols. Specifically, the puncturer 550 perform a puncturing operation in response to a puncturing enable signal PUNC_EN from the OR gate 540. That is, the puncturing enable signal PUNC_EN is a puncturing pattern for determining the puncturing operation of the puncturer 550. The N-symbol stream output from the puncturer 550 is interleaved by the channel interleaver 100 having the interleaver size N.

The symbol index generator 510 sequentially generates indexes indicating the symbols constituting the stream of LM repeated symbols. The symbol index generator 510 can be realized with a counter. The modulo operator 520 receives the index k generated from the symbol index generator 510 and D 1, and generates the puncturing enable signal PUNC_EN of ‘1’, when the k^{th} coded symbol corresponds to a coded symbol at a puncturing position. For example, in the modulo operator 520, “when the k^{th} coded symbol corresponds to a coded symbol at a puncturing position” refers to when the k^{th} coded symbol corresponds to a multiple of D1. The modulo operator 530 receives the index k generated from the symbol index generator 510 and D2, and generates the puncturing enable signal PUNC_EN of ‘1’, when the k^{th} coded symbol corresponds to a coded symbol at a puncturing position. For example, in the modulo operator 530, “when the k^{th} coded symbol corresponds to a coded symbol at a puncturing position” refers to when the k^{th} coded symbol corresponds to ((a multiple of D2)−D2+└D1/2┘). The OR gate 540 generates the puncturing enable signal PUNC_EN by ORing the outputs of the modulo operators 520 and 530, and provides the generated puncturing enable signal PUNC_EN to the puncturer 550.

D1 and D2, as described with reference to Table 6, Equations (1) and (2), and FIG. 9, are the puncturing interval values for determining the interval between the symbols to be punctured in the stream of the coded symbols within one frame. The first puncturing interval D1 is defined as the minimum integer larger than LM/P for the number, P=LM−N, of the symbols to be punctured. The second puncturing interval D2 is defined as sD1 for a selected one integer ‘s’ out of integers smaller than or equal to the maximum integer smaller than P1/P2. Here, P1 indicates the first symbol puncturing number and is defined as the maximum integer smaller than LM/D1. P2 indicates the second symbol puncturing number determined by a difference between the total number P of the symbols to be punctured and the first symbol puncturing number P1. That is, D1=┌LM/P┐, P132 └LM/D1┘, P2=P−P1, D2=sD1, and s≦└P1/P2┘. The puncturing intervals D1 and D2 and the symbol puncturing numbers P1 and P2 are provided from a puncturing pattern determiner (not shown). The puncturing pattern determiner, the modulo operators 520 and 530, and the OR gate 540 serve as a puncturing pattern generator for generating a puncturing enable signal for determining a puncturing operation of the puncturer 550.

Referring to FIG. 14, as in the flexible data rate matching device shown in FIG. 13, the flexible data rate matching device according to an embodiment of the present invention includes the channel encoder 10, the repeater 110, the puncturer 550, the channel interleaver 100, and the symbol index generator 510. The flexible data rate matching device shown in FIG. 14 is featured by including a puncturing pattern generator 560 in place of the modulo operators 520 and 530 and the OR gates 540 of FIG. 10. By doing so, the flexible data rate matching device is realized by software. The puncturing pattern generator 560 stores an address generator module program, and generates the puncturing enable signal PUNC_EN of ‘1’ when k satisfies a specific condition according to the program. The puncturing pattern generator 560 determines the k^{th} coded symbols corresponding to the case where k is (a multiple of D1) or ((a multiple of D2)−D2+└D1/2┘), to puncture the determined coded symbols. The puncturing pattern generator 560 may also determine the k^{th} coded symbols corresponding to the case where k is (a multiple of D1) or ((a multiple of D2)−D2−└D1/2┘), to puncture the determined coded symbols. Then, the flexible data rate matching device actually outputs N symbols out of LM symbols, as in the flexible data rate matching device of FIG. 13.

Performance Analysis

In the following description, a change in performance according to puncturing of the coded symbols encoded with the convolutional code is analyzed, and an average performance change of a convolutional code with a code rate R according to a puncturing rate and a repetition rate is described. From this, it is possible to predict a performance difference between the conventional IS-2000 FDRT algorithm and the novel FDRT algorithm proposed in the invention, and an average performance value.

First, the reference letters used herein will be defined as follows:

R: a code rate of the convolutional code, R=k/n;

Rst: (data rate of coded symbols actually transmitted over the channel)×R, Rst=NR(bits/sec); and

Rfdrt: (data rate of coded symbol output from the channel encoder in the FDRT mode)×R, Rfdrt=LR(bits/sec).

When the uniform puncturing or repetition pattern is used, a performance change caused by the puncturing or repetition is given by Equation (3) below. Here, when Rfdrt<Rst, the FDRT scheme performs symbol repetition, so that the performance, i.e., coding gain, is improved. However, in contrast, when Rfdrt>Rst, the FDRT scheme performs symbol puncturing, so that the performance, i.e., coding gain, is degraded. As mentioned before, however, since N>L, the FDRT scheme generally performs symbol repetition, thus increasing the performance, i.e., coding gain. The point at issue is how the coding gain can be increased according to the pattern.

Average Coding Gain=10 log₁₀ (Rst/Rfdrt) dB Equation (3)

For example, when Rst=19.2 Kbps, the coding gains according to Rfdrt are shown in Table 7. Therefore, if the puncturing pattern or the repetition pattern is properly determined and the FDRT algorithm is used, the coding gains shown in Table 7 should be guaranteed.

TABLE 7

| | Rst | Rfdrt | Average Coding Gain |
|---|---|---|---|
| CASE 1 | 19.2 Kbps | 17.5 Kbps | 0.40 (dB) |
| CASE 2 | 19.2 Kbps | 15 Kbps | 1.07 (dB) |
| CASE 3 | 19.2 Kbps | 10 Kbps | 2.83 (dB) |

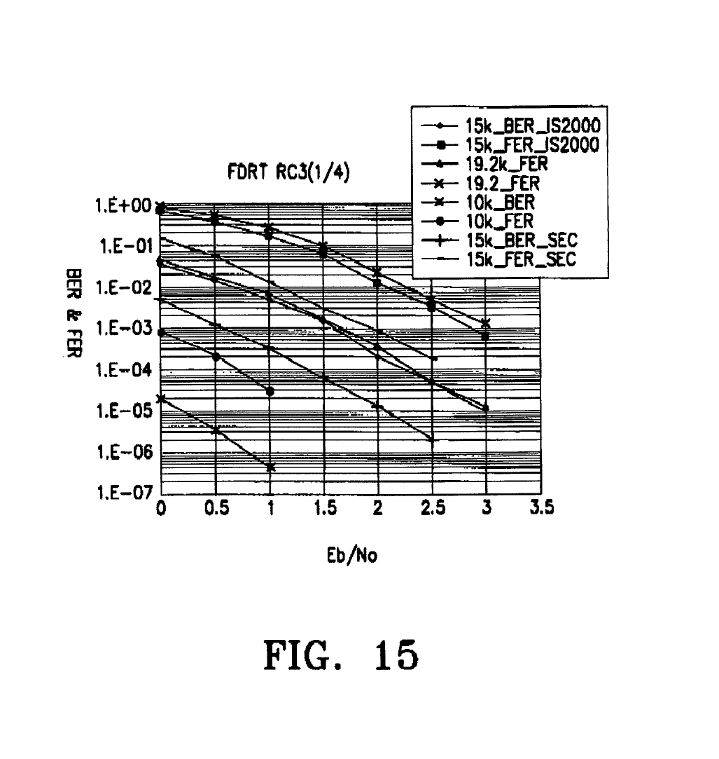

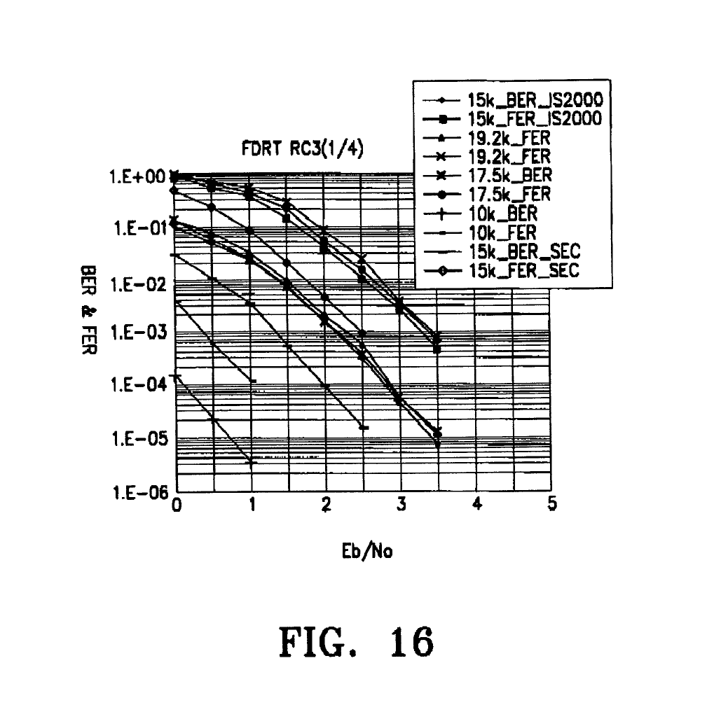

FIGS. 15 and 16 illustrate a comparison between the simulation results of the novel FDRT algorithm and the simulation results of the conventional FDRT algorithm.

FIG. 15 is a graph illustrating the simulation results for the case where the present invention is applied to the IS-2000 RC3 (Code Rate R=¼). This graph is obtained under the following simulation environment. Case (1), Case (2) and Case (3) are given the simulation environments shown in Tables 8, 9 and 10, respectively. In Case (1), a data rate is 15 Kbps, the number of coded symbols per frame is L=1200, and the interleaver size is N=1536. Here, 15k_BER_IS2000 and 15k_FER_IS200 indicate the simulation results according to the prior art, while 15k_BER_SEC and 15k_FER_SEC indicate the simulation results according to the present invention. In Case (2), a data rate is 10 Kbps, the number of coded symbols per frame is L=800, and the interleaver size is N=1536. In this case, only the simulation results according to the prior art are shown. In Case (3), a data rate is 19.2 Kbps. In this case, there occurs no symbol puncturing/repetition.

TABLE 8
CASE (1)

Data Rate 15 kbps (Pure info + CRC + Tail bit = 300 bit)
L (Encoded size) = 1200
M = 2, N (Channel Interleaver Size) = 1536,
P (Num of Puncturing) = L × M − N = 864
D (Puncturing Depth) = └(L × M)/P┘ = 2
Puncturing Pattern
→ Comparison Subject:
15 kbps signal (Same Puncturing Symbol Number)
→ Puncturing Pattern
15KBER_SEC, 15KFER_SEC: NEW Algorithm Type 1 Used
if (k%3 = 2 ∥ k%36=0)(k = 0,1,2, . . . , 2399) Then Puncturing
15KBER_IS2000, 15KFER_IS2000: Old Puncturing Pattern Used

TABLE 9
CASE (2)

Data Rate 10 kbps (Pure info + CRC + Tail bit = 200 bit)
L (Encoded size) = 800
M = 2, N (Channel Interleaver Size) = 1536,
P (Num of Puncturing) = L × M − N = 64
D (Puncturing Depth) = └(L × M)/P┘ = 25
Old Puncturing Pattern Used

TABLE 10
REFERENCE)

Reference Curve: 19.2 kbps, No Puncturing. No Repetition.

Referring to FIG. 15, as shown in the RC3 simulation results, the FDRT scheme (15k_BER_SEC, and 15k_FER_SEC) according to the present invention provides a gain Eb/No of about 0.9 dB to 1.0 dB, as compared with the conventional IS-2000 FDRT scheme (15k_BER_IS2000, and 15k_FER _IS2000). This almost approaches the average coding gain 1.07 dB, compared with 19.2 Kbps, as set forth in Table 7. Such results are obtained by generating the uniform puncturing and repetition pattern, and the performance also shows an almost optimal performance. Therefore, FDRT Condition (1) and FDRT Condition (2) of the FDRT algorithm proposed in the invention play an important role in the performance, and the new FDRT Algorithm Type 1 reflecting the conditions can also provide high performance. However, it is noted that the simulation results for the conventional IS-2000 FDRT algorithm unexpectedly provide a coding gain of about 0.1 dB. Such a problem is caused by the asymmetric pattern concentrated at the end of the frame, as described before. In conclusion, in the same channel condition, there occurs a performance difference of about 0.9 to 1.0 dB according to the FDRT pattern.

FIG. 16 is a graph illustrating the simulation results for the case where the invention is applied to the RC4 SCH (Code Rate R=½). This graph is obtained under the following simulation environment. Case (1), Case (2) and Case (3) are given the simulation environments shown in Tables 11, 12 and 13, respectively. In Case (1), a data rate is 15 Kbps, the number of coded symbols per frame is L=600, and the interleaver size is N=768. Here, 15k_BER_IS2000 and 15k_FER_IS200 indicate the simulation results according to the prior art, while 15k_BER_SEC and 15k_FER_SEC indicate the simulation results according to the present invention. In Case (2), a data rate is 17.5 Kbps, the number of coded symbols per frame is L=700, and the interleaver size is N=768. In this case, only the simulation results according to the prior art are shown. In Case (3), a data rate is 10 Kbps, the number of coded symbols per frame is L=400, and the interleaver size is N=768. In this case, only the simulation results according to the prior art are shown. In Case (4), the data rate is 19.2 Kbps. In this case, there occurs no symbol puncturing/repetition.

TABLE 11
CASE (1)

Data Rate 15 kbps (Pure info + CRC + Tail bit = 300 bit)
L (Encoded size) = 600
M = 2, N (Channel Interleaver Size) = 768,
P (Num of Puncturing) = L × M − N = 432
D (Puncturing Depth) = └(L × M)/P┘ = 2
Puncturing Pattern
→ Comparison Subject: 15 kbps signal (Same Puncturing
Symbol Number)
→ Puncturing Pattern
15KBER_SEC, 15KFER_SEC: NEW Algorithm Type 1 Used
if (k%3 = 2 ∥ k%36 = 0)(k = 0, 1, 2, . . . , 2399) Then Puncturing
15KBER_IS2000, 15KFER_IS2000: Old Puncturing Pattern Used

TABLE 12
CASE (2)

Data Rate 17.5 kbps (Pure info + CRC + Tail bit = 350 bit)
L (Encoded size) = 700
M = 2, N (Channel Interleaver Size) = 768,
P (Num of Puncturing) = L × M − N = 632
D (Puncturing Depth) = └(L × M)/P┘ = 2
Old Puncturing Pattern Used

TABLE 13
CASE (3)

Data Rate 10 kbps (Pure info + CRC + Tail bit = 200 bit)
L (Encoded size) = 400
M = 2, N (Channel Interleaver Size) = 768,
P (Num of Puncturing) = L × M − N = 32
D (Puncturing Depth) = └(L × M)/P┘ = 25
Old Puncturing Pattern Used

Referring to FIG. 16, the RC4 simulation results are also equal to the simulation results shown in FIG. 15. As illustrated in FIG. 16, the FDRT scheme (15k_BER_SEC, and 15k_FER_SEC) according to the present invention provides a gain Eb/No of about 0.8 dB to 0.9 dB, as compared with the conventional IS-2000 FDRT scheme (15k_BER_IS2000, and 15k_FER_IS2000).

What is important next is the 10 Kbps performance. In this case, the conventional FDRT algorithm almost approaches the average coding gain 2.83 dB shown in Table 7. Such results are obtained because the puncturing distance D for the case of 10 Kbps is set to an integer, so that the non-uniform puncturing due to the difference of LM/P−D does not occur in the process of determining the puncturing distance D. Therefore, this is a good example showing that the performance is linked directly with the prior condition that the difference of LM/P−D should be fully considered in the process of determining the puncturing distance D. Table 14 below shows the simulation environment for this performance.

TABLE 14

Data Rate 10 kbps (Pure info + CRC + Tail bit = 200 bit)
L (Encoded size) = 800
M = 2, N (Channel Interleaver Size) = 1536,
P (Num of Puncturing) = LM − N = 64
D (Puncturing Depth) = └LM/P┘ = 1600/64 = 25 = 25
Old Puncturing Pattern Used

As described above, the novel FDRT scheme according to the present invention matches a frame having coded symbols flexibly determined according to variation of a data rate to the interleaver size in the data communication system. The FDRT scheme uniformly distributes the puncturing pattern or repetition pattern within the frame by adjusting initial setting values, thereby making it possible to flexibly transmit data according to a data rate without performance degradation.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for generating a stream of N symbols by puncturing a stream of repeated symbols in a system including an encoder for generating a stream of L symbols, a repeater for repeating the stream of L symbols, and a puncturer for puncturing the stream of repeated symbols and generating a stream of N symbols, where N is larger than L, the method comprising the steps of:
generating a stream of LM repeated symbols by repeating the stream of L symbols M times, where M is an minimum integer larger than N/L;
calculating a first puncturing interval D1 defined as a minimum integer larger than LM/P for a number, P=LM−N, of symbols to be punctured, and a first symbol puncturing number P1 defined as a maximum integer smaller than LM/D1;
calculating a second symbol puncturing number P2 indicating a difference between the number P of the symbols to be punctured and the first symbol puncturing number P1, and a second puncturing interval D2 defined as sD1 for a selected one integer s out of integers smaller than or equal to a maximum integer smaller than P1/P2; and
generating a stream of N symbols by puncturing the stream of LM repeated symbols at the first puncturing interval D1 and the second puncturing interval D2.

2. The method as claimed in claim 1, wherein positions of the symbols punctured at the first puncturing interval D1 are inconsistent with positions of the symbols punctured at the second puncturing interval D2.

3. The method as claimed in claim 1, wherein the symbols punctured at the first puncturing interval D1 are equivalent to symbols located at the positions corresponding to a multiple of D1 from initial symbols in the stream of LM repeated symbols.

4. The method as claimed in claim 1, wherein the symbols punctured at the second puncturing interval D2 are equivalent to symbols located at the positions corresponding to a multiple of D2 plus an offset from initial symbols in the stream of LM repeated symbols.

5. The method as claimed in claim 4, wherein the offset is 1.

6. The method as claimed in claim 4, wherein the offset is −1.

7. The method as claimed in claim 4, wherein the offset is equivalent to a value determined by subtracting D2 from a maximum integer smaller than D1/2.

8. The method as claimed in claim 4, wherein the offset is equivalent to a value determined by multiplying −1 by a value obtained by adding D2 to a maximum integer smaller than D1/2.

9. An apparatus for matching L coded symbols determined according to a variation of a data rate to an interleaver size N, wherein N is larger than L, the apparatus comprising:
an encoder for generating a stream of L coded symbols;
a repeater for repeating the stream of L coded symbols M times and outputting a stream of LM repeated symbols, wherein M is defined as a minimum integer larger than N/L;
a puncturing pattern generator for (a) determining a first puncturing interval D1 defined as a minimum integer larger than LM/P for a number, P=LM−N, of symbols to be punctured, and a first symbol puncturing number P1 defined as a maximum integer smaller than LM/D1;
(b) calculating a second symbol puncturing number P2 indicating a difference between the number P of the symbols to be punctured and the first symbol puncturing number P1, and a second puncturing interval D2 defined as sD1 for a selected one integer s out of integers smaller than or equal to a maximum integer smaller than P1/P2;
(c) generating a puncturing pattern used for puncturing the stream of LM repeated symbols at the first puncturing interval D1 and the second puncturing interval D2; and
a puncturer for puncturing the stream of LM repeated symbols according to the puncturing pattern at the first puncturing interval D1 and the second puncturing interval D2, and generating a stream of N symbols.

10. The apparatus as claimed in claim 9, further comprising a symbol index generator for generating indexes indicating respective symbols constituting the stream of LM symbols, and providing the generated indexes to the puncturing pattern generator, wherein the puncturing pattern generator generates the puncturing pattern indicating symbols corresponding to the first and second puncturing intervals D1 and D2 out of the symbols in the stream of LM symbols.

11. The apparatus as claimed in claim 9, further comprising an interleaver for interleaving an output of the puncturer before transmission.

12. The apparatus as claimed in claim 9, wherein positions of the symbols punctured at the first puncturing interval D1 are inconsistent with positions of the symbols punctured at the second puncturing interval D2.

13. The apparatus as claimed in claim 9, wherein the symbols punctured at the first puncturing interval D1 are equivalent to symbols located at the positions corresponding to a multiple of D1 from initial symbols in the stream of LM repeated symbols.

14. The apparatus as claimed in claim 9, wherein the symbols punctured at the second puncturing interval D2 are equivalent to symbols located at the positions corresponding to a multiple of D2 plus an offset from initial symbols in the stream of LM repeated symbols.

15. The apparatus as claimed in claim 14, wherein the offset is 1.

16. The apparatus as claimed in claim 14, wherein the offset is −1.

17. The apparatus as claimed in claim 14, wherein the offset is equivalent to a value determined by subtracting D2 from a maximum integer smaller than D1/2.

18. The apparatus as claimed in claim 14, wherein the offset is equivalent to a value determined by multiplying −1 by a value obtained by adding D2 to a maximum integer smaller than D1/2.

19. A method for matching L coded symbols determined according to a variation of a data rate to an interleaver size N, wherein N is larger than L, the method comprising the steps of:
repeating a stream of L coded symbols M times and outputting a stream of LM repeated symbols, wherein M is defined as a minimum integer larger than N/L;
puncturing the stream of LM repeated symbols by a first symbol puncturing number P1 according to a first puncturing pattern A, wherein P1 is defined as a maximum integer smaller than LM/D1, wherein the first puncturing pattern A indicates a multiple of a first puncturing interval D1 defined as a minimum integer larger than LM/P for a number, P=LM−N, of symbols to be punctured; and
puncturing remaining symbols after puncturing of the stream of LM symbols at the first puncturing interval D1, according to a second puncturing pattern B and outputting a stream of N symbols, when the second symbol puncturing number P2 indicating a difference between the number P of the symbols to be punctured and the first symbol puncturing number P1 is larger than 0, wherein the second puncturing pattern B is equivalent to a value determined by adding an offset to a multiple of the second puncturing interval D2 which is defined as sD1 for a selected one integer s out of integers smaller than or equal to a maximum integer smaller than P1/P2.

20. The method as claimed in claim 19, wherein symbol positions determined by the first puncturing pattern A are inconsistent with symbol positions determined by the second puncturing pattern B.

21. The method as claimed in claim 19, wherein the offset is 1.

22. The method as claimed in claim 19, wherein the offset is −1.

23. The method as claimed in claim 19, wherein the offset is equivalent to a value determined by subtracting D2 from a maximum integer smaller than D1/2.

24. The method as claimed in claim 17, wherein the offset is equivalent to a value determined by multiplying −1 by a value obtained by adding D2 to a maximum integer smaller than D1/2.
